(19) United States
(12) Patent Application Publication
(10) Pub. No.: US 2023/0383527 A1
(43) Pub. Date: Nov. 30, 2023

(54) SELF-ADHERED SYSTEM FOR SEALING BETWEEN ADJACENT BUILDING STRUCTURAL ELEMENTS

(71) Applicants: DDP SPECIALTY ELECTRONC MATERIALS US, LLC, WILMINGTON, DE (US); DUPONT SAFETY & CONSTRUCTION, INC., WILMINGTON, DE (US)

(72) Inventors: GERALD F BILLOVITS, MIDLAND, MI (US); ANDREA WAGNER WATTS, MIDLAND, MI (US); JAMES KATSAROS, WILMINGTON, DE (US); TIMOTHY FOURNIER, MIDLAND, MI (US)

(21) Appl. No.: 18/305,706

(22) Filed: Apr. 24, 2023

Related U.S. Application Data
(60) Provisional application No. 63/338,108, filed on May 4, 2022.

(51) Int. Cl. E04B 1/68; E06B 1/62; C09J 7/38

(52) U.S. Cl. CPC E04B 1/68; E06B 1/62; C09J 7/38; C09J 2301/302; C09J 2301/312; C09J 2301/16

(57) ABSTRACT

Gaps between adjacent members in a building construction are sealed by applying a self-adhering barrier sheet to the adjacent members to span the gap. The self-adhering barrier sheet includes a flexible sheet of a barrier material. The flexible sheet has opposing edges, of which at least one is tapered. A pressure sensitive adhesive is applied to at least a portion of at least one major surface of the flexible sheet. The edges of the self-adhering barrier sheet are adhered to the adjacent structural elements by means of the pressure sensitive adhesive. The pressure sensitive adhesive has a thickness equal to or less than the maximum thickness of the flexible sheet. Where two self adhering barrier sheets overlap at an angle on a substrate, the tapered edge of the underlying sheet allows a smooth transition for the overlapping sheet, preventing the formation of an open gap between the barrier sheets and the substrate where air and moisture can penetrate.

### BACKGROUND OF THE INVENTION

The present invention relates to methods and barrier materials for sealing openings between adjacent building structural elements.

Structural elements such as windows and doors are often inserted into rough openings in a building structure. The rough opening is typically somewhat larger than the structural elements being inserted, to allow for easy installation. This produces gaps between the structural element and the building structure. These gaps must be sealed to prevent air and water penetration. This can be done by installing a backer rod and caulking or installing an insulating foam, but these methods are laborious, require skilled workers, and are unsatisfactory when the gap is large.

The gap can instead be covered by applying an elastomeric sheet over it, adhering the sheet to both the building framing members and the inserted structural element. These elastomeric sheets need to be strong enough to resist damage during installation. They also must be able to accommodate movement of the building framing members and/or inserted structural element that occurs during the life of the building. This movement can result from factors such as thermal expansion and contraction; settling of the building and/or the underlying ground; seismic events and percussive and/or acoustic events. In some cases, this movement can be quite significant. Additionally, the seal must remain intact over long periods of time. These needs require the elastomeric sheet material to be rather robust. Thin films such as flashing tapes and house wraps typically do not have the necessary mechanical properties and durability.

Being designed with these mechanical and durability concerns in mind, elastomeric sheets have proven to be difficult to lay down uniformly, especially at corners, where they are folded over themselves or overlapped. It is difficult to obtain a good seal at the point of overlap when the elastomeric sheet has the mechanical properties and durability required in this application. This problem is illustrated in FIG. 1. Elastomeric sheets 1 and 2 are shown applied to substrate 4 in an overlapping manner. Adhesive layers 3 and 3A secure elastomeric sheet 1 to substrate 4 and elastomeric sheet 2 to elastomeric sheet 1, respectively. Gap 5 is produced at the edge of elastomeric sheet 1, where it is overlapped by elastomeric sheet 2. This gap represents a potential point of air and water leakage.

U.S. Pat. No. 8,261,498 describes a barrier system for sealing around windows that includes an interlocking adaptor that attaches to the window frame and a sealing membrane assembly featuring a projection that inserts into a slot on the adaptor. Pre-molded, generally L-shaped pieces are also described for sealing around window corners. While the L-shape of the sealing membrane corner piece allows it to seal around corners of the window without producing overlaps at the corners, these overlaps are merely transposed to positions along the sides, top and bottom of the window, intermediate to the corners. The problem of obtaining an adequate seal at the overlaps remains. In addition, this adaptor and sealing membrane system requires specially made, complex parts and is difficult to install. The requirement for inserting the projection into the slot introduces an extra point for potential failure, as the adaptor and sealing membrane must not only be sealed to the window and to the building frame members, but also be well aligned to allow proper insertion of the projection. And while the adaptor and sealing membrane are made to engage with each other and produce a seal, in practice this seal must be supplemented with an additional sealant or adhesive.

### BRIEF SUMMARY OF THE INVENTION

In one aspect, this invention is a method of sealing a gap between adjacent structural elements in a building construction, comprising:

applying a self-adhering barrier sheet to the adjacent members to span the gap with the self-adhering barrier sheet, wherein the self-adhering barrier sheet comprises a flexible sheet of a barrier material, the flexible sheet having opposing edges, at least one of said opposing edge being a tapered edge, and a pressure sensitive adhesive applied to at least a portion of at least one major surface of the flexible sheet, whereby said at least one tapered edge is adhered to one of the adjacent structural elements by means of the pressure sensitive adhesive and the opposing edge is adhered to the other of the adjacent structural elements by means of the pressure sensitive adhesive, wherein the flexible sheet has a minimum thickness of at least 0.5 mm and the pressure sensitive adhesive has a thickness equal to or less than the maximum thickness of the flexible sheet.

The method of the invention has advantages of easy and inexpensive installation. The barrier sheets are simply cut to length and applied. The pressure sensitive adhesive, being pre-applied to the flexible sheet, does not require on-site application; therefore, there is no general need for separate liquid adhesives or sealants. There is also no need to carefully align separate components of a multi-part barrier system such as is described in U.S. Pat. No. 8,261,498.

This invention provides a further, significant advantage in installations wherein separate sections of the self-adhering barrier sheet are applied and overlap at an angle, with an overlapping section of self-adhering barrier sheet being applied onto an overlapped section of self-adhering barrier sheet by crossing over at least one tapered edge of the overlapped section of self-adhering barrier sheet. The tapered edge of the overlapped self-adhering barrier sheet allows for the minimization or elimination of a gap (i.e., the gap indicated by reference numeral 5 of FIG. 1) along the line of intersection of the two barrier sheets, allowing for a tight seal with reduced or no leakage, and without the need to separately seal that intersection. The flexible sheet, having a thicker, central section, retains the mechanical properties and durability required of these sealing products.

In a particular embodiment, this invention is a method of sealing an open joint between a building structure and an insert positioned within an opening in the building structure, comprising:

applying a self-adhering barrier sheet to the insert and the building structure to span the open joint with the self-adhering barrier sheet, wherein the self-adhering barrier sheet comprises a flexible sheet of a barrier material, the flexible sheet having opposing tapered edges and a pressure sensitive adhesive applied to at least a portion of at least one major surface of each of the tapered edges, whereby one of the opposing tapered edges is adhered to the insert by means of the pressure sensitive adhesive applied to said one of the opposing tapered edges and the other opposing tapered edge is adhered to the building structure by means of the pressure sensitive adhesive applied to said other opposing tapered edge.

As before, this embodiment has the benefits of easy and inexpensive installation, and of producing a tight seal between overlapping sections of the flexible barrier sheet. Accordingly, in an embodiment of particular interest, the insert has multiple insert sides, each pair of adjacent multiple insert sides defining a vertex. Typically this opening would conform to a quadrilateral, often with roughly 90 degree corners like a square or rectangle, but more generally the insert may be a polygon having general polygons with 3 or more straight or curved sides and correspondingly three or more vertices. Open joints are defined by each of said multiple insert sides and an adjacent side of the opening in the building structure. Separate sections of a self-adhering barrier sheet are applied to seal each of the open joints. The separate sections of self-adhering barrier sheet overlap at the vertices.

In another aspect, the invention is a self-adhering barrier sheet comprising;
a) a flexible sheet of a barrier material having a glass transition temperature of no greater than −40° C., the flexible sheet having a pair of opposing tapered edges and a minimum thickness of at least 0.5 mm at the widest point away from the edge, and
b) a pressure sensitive adhesive applied to at least one side of each of the opposing tapered edges, the pressure sensitive adhesive having a thickness no greater than the maximum thickness of the flexible sheet.

### BRIEF DESCRIPTION OF THE DRAWINGS

FIG. 1 is an enlarged cross-sectional view of a joint formed in a prior art process between two overlapping layers of flexible barrier sheet.

FIG. 2A is a front view of a wall with an opening and a window assembly inserted into the opening.

FIG. 2B is a front view of the wall and window assembly of FIG. 2A, after installation of the self-adhering barrier sheets of the invention.

FIG. 3 is a side view, taken along lines 3-3 of FIG. 2B, of a self-adhering barrier sheet of the invention.

FIG. 4 is a side section view, taken along line 4-4 of FIG. 2B, of overlapping self-adhering barrier sheets applied to a building construction in accordance with the invention.

FIG. 5A is a side view of a flexible sheet for use in a self-adhering barrier sheet of the invention.

FIG. 5B is a side view of a second flexible sheet for use in a self-adhering barrier sheet of the invention.

FIG. 5C is a side view of a third flexible sheet for use in a self-adhering barrier sheet of the invention.

FIG. 6 is a schematic view of an installation of self-adhering barrier sheets of the invention to seal around a protruding insert in a building structure.

### DETAILED DESCRIPTION OF THE INVENTION

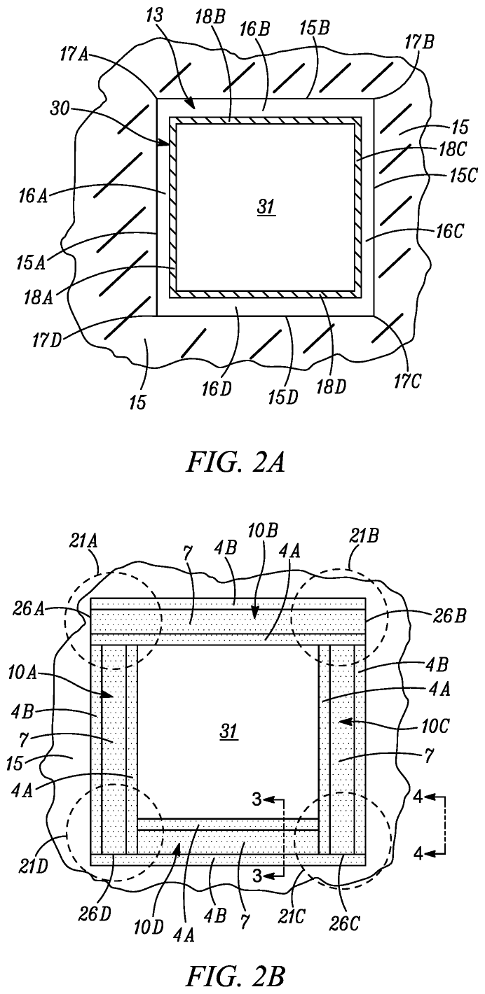

Turning to FIG. 2A, there is shown a portion of building structure 15 (in this case a wall), having opening 13 defined by sides 15A, 15B, 15C and 15D of opening 13. Insert in this case consisting of window 31 and window frame members 18A, 18B, 18C and 18D, is positioned within opening 13. Window frame members 18A, 18B, 18C and 18D form the sides of insert 30. Adjacent pairs of window frame members form corners 17A, 17B, 17C and 17D. Open joint 16A resides between side 15A of opening 13 and window frame member 18A, open joint 16B resides between side 15B of opening 13 and window frame member 18B, open joint 16C resides between side 15C of opening 13 and window frame member 18C, open joint 16D resides between side 15D of opening 13 and window frame member 18D.

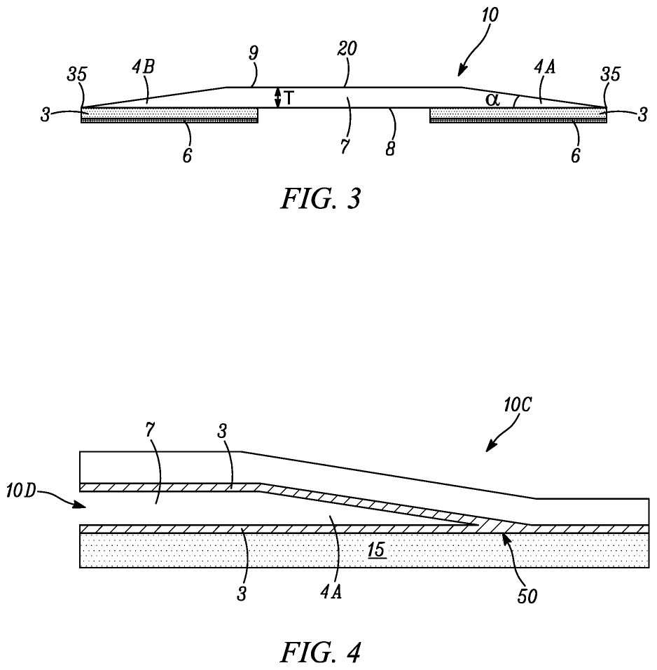

Referring now to FIG. 2B, self-adhering barrier sheets 10A, 10B, 10C and 10D of the invention are applied to cover each of open joints 16A, 16B, 16C and 16D (respectively) of FIG. 2A. Self-adhering barrier sheets 10A-10D each comprises flexible sheet 20 of a barrier material as depicted in FIG. 3, in which flexible sheet 20 has a cross-sectional profile as shown in FIG. 3. As shown in FIG. 3, flexible sheet 20 has opposing tapered edges 4A and 4B; tapered edges 4A and 4B are “opposing” in that they reside on opposite sides of flexible sheet 20 By “tapered”, it is meant the thickness of flexible sheet 20 diminishes within tapered edges 4A and 4B in a continuous (but not necessarily constant) fashion in the direction towards its outside terminus 35. The “tapered edge” is that portion of each opposing side of flexible sheet 20 in which there is a continuous diminution of thickness. In the embodiment shown in FIG. 3, flexible sheet includes an optional central section 7 of maximum thickness T and tapered edges 4A and 4B. Each of tapered edges 4A and 4B, as shown, diminishes in thickness towards its respective outside terminus 35.

In the embodiment shown in FIG. 3, this diminution in thickness in tapered edges 4A and 4B is constant, i.e., the thickness of tapered edges 4A and 4B each decreases linearly with distance toward their respective outer termini 35. In addition, flexible sheet as shown in FIG. 3 has a flat bottom surface 8 and a non-planar top surface 9, top surface 9 being beveled on opposing sides to produce tapered edges 4A and 4B. As used herein, the “bottom” surface of flexible sheet 20 is the major surface which becomes adhered to members of a building structure; the “top” surface is the opposing major surface of flexible sheet 20.

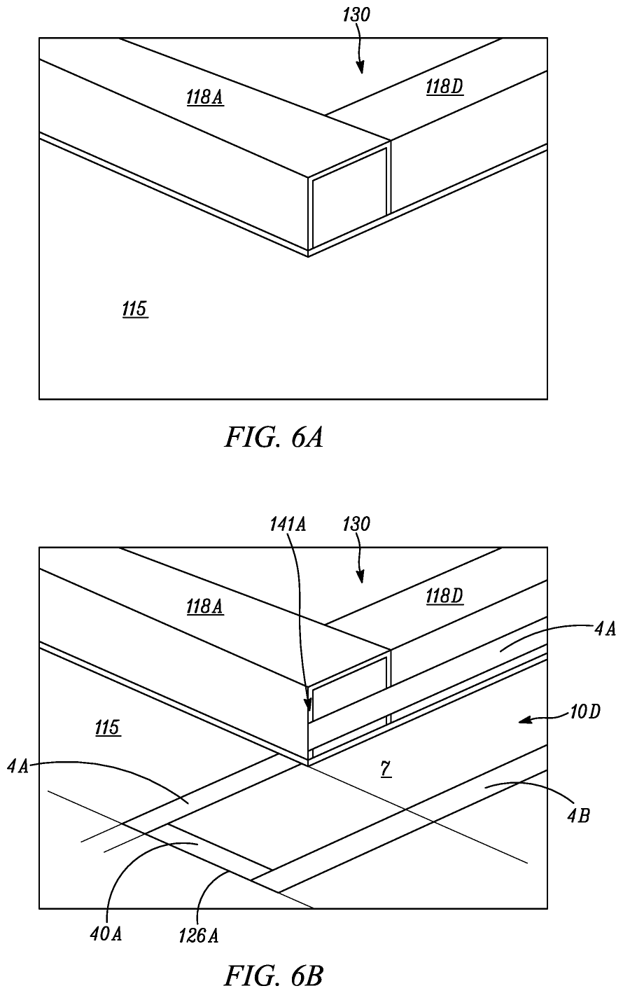

Exemplary alternate configurations for tapered edges 4A and 4B of flexible sheet are shown in FIGS. 5A, 5B and 5C. In FIG. 5A, top surface 9 is flat and bottom surface 8 is beveled to produce tapered edge 4A. In FIG. 5B, both top surface 9 and bottom surface 8 are beveled to produce tapered edge 4A. In FIG. 5C, a curved bevel on top surface 9 produces tapered edge 4A, bottom surface 8 being flat. Tapered edge 4A in FIG. 5C exhibits a continuous but non-uniform diminution in thickness.

The tapered edges 4A and 4B illustrated in FIG. 3 form an included angle a which is no greater than 30 degrees. The included angle a may be no greater than 20 degrees, no greater than 15 degrees or no greater than 10 degrees. Included angle a is defined as the angle between the maximum thickness of sheet 20 and the absolute edge as defined as the respective outer termini 35.

The width of tapered edges 4A and 4B each may be, for example, 1 to 25 mm or more. In some embodiments, the width of tapered edges 4A and 4B each is at least 3 mm or at least 5 mm, and up to 15 mm or up to 20 mm. The maximum thickness T of flexible sheet 20 is at least 0.5 mm and may be, for example, at least 0.75 mm, at least 1.0 mm and up to 5 mm, up to 3 mm or up to 2 mm.

The thickness of flexible sheet 20 at the outer termini 35 of tapered edges 4A and 4B (see, e.g., FIG. 3) is as small as practical, preferably being no greater than 0.1 mm, no greater than 0.05 or no greater than 0.01 mm.

Self-adhering barrier sheet 10 further includes pressure sensitive adhesive 3 (FIG. 3). The pressure sensitive adhesive is applied to the bottom of flexible sheet 20 in at least those areas at which flexible sheet 20 is to be adhered to a building structure (such as wall 15 and insert 30 of FIG. 2A). The pressure sensitive adhesive preferably is applied to two opposing edges of the bottom surface 8 of flexible sheet 20, including at least a portion of one or both (if two are present) of tapered edges 4A and 4B. As shown in FIG. 3, the pressure sensitive adhesive is applied to bottom surface 8 of each of tapered edges 4A and 4B respectively, which is a preferred arrangement. The pressure sensitive adhesive may be applied to only a portion of the width of tapered edges 4A and 4B. The pressure sensitive may be applied to all or a portion of central section 7 (when present), as shown in FIG. 3. The pressure sensitive adhesive applied to tapered edge 4A may be the same as or different than the pressure sensitive adhesive applied to the opposing edge 4B.

Turning back to FIG. 2B, a tapered edge 4A of each of self-adhering barrier sheets 10A, 10B, 10C, and 10D are adhered to insert 30 via pressure sensitive adhesive 3 (FIG. 3), and an opposing edge 4B (which is also tapered in the embodiment shown) is adhered via pressure sensitive adhesive 3 (FIG. 3) to building structure 15, covering open joints 16A, 16B, 16C and 16D (FIG. 2A), respectively.

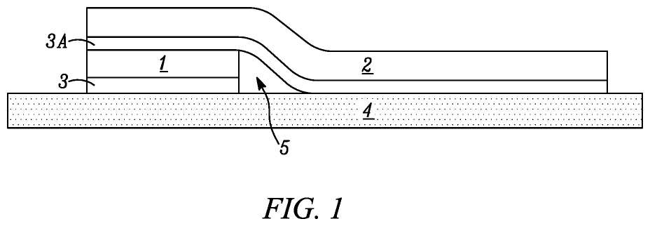

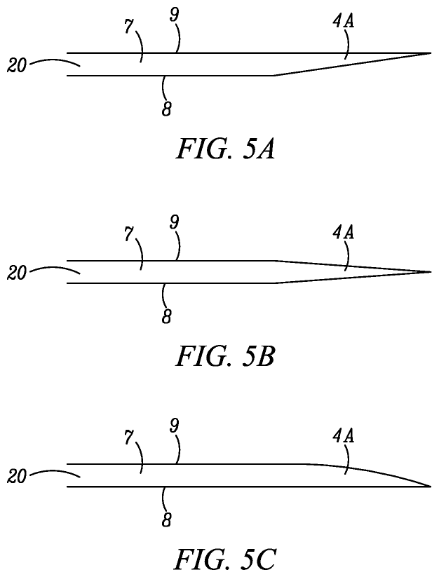

Self-adhering barrier sheet 10C overlaps self-adhering barrier sheet 10D at corner 17C, in the region identified by circle 21C. In overlapping self-adhering barrier sheet 10D, self-adhering barrier sheet 10C crosses over tapered edge 4A of self-adhering barrier sheet 10D and, as shown more particularly in FIG. 4, continues as an optional but preferred feature to overlap central section 7 and tapered edge 4B of self-adhering barrier sheet 10D. As shown at arrow 50 in FIG. 4, providing a tapered edge 4A to the overlapped self-adhering barrier sheet 10D eliminates the gap 5 present in the prior art arrangement (FIG. 1).

Similarly, self-adhering barrier sheet 10A overlaps self-adhering barrier sheet 10D at corner 17D, in the region identified by circle 21D; self-adhering barrier sheet 10B overlaps self-adhering barrier sheet 10A at corner 17A, in the region identified by circle 21A, and self-adhering barrier sheet 10B overlaps self-adhering barrier sheet 10C at corner 17B, in the region identified by circle 21B. In each case, the overlapping self-adhering barrier sheet crosses over a tapered edge 4A of the overlapped self-adhering barrier sheet and also overlaps the central portion 7 and tapered edge 4B of the overlapped self-adhering barrier sheet.

Exposed seams 26A, 26B, 26C and 26D may be sealed using a separate adhesive, sealant or tape, in the case that pressure sensitive adhesive applied to self-adhering barrier sheets 10A, 10B, 10C and 10D does not span the entire width of the respective self-adhering barrier sheets.

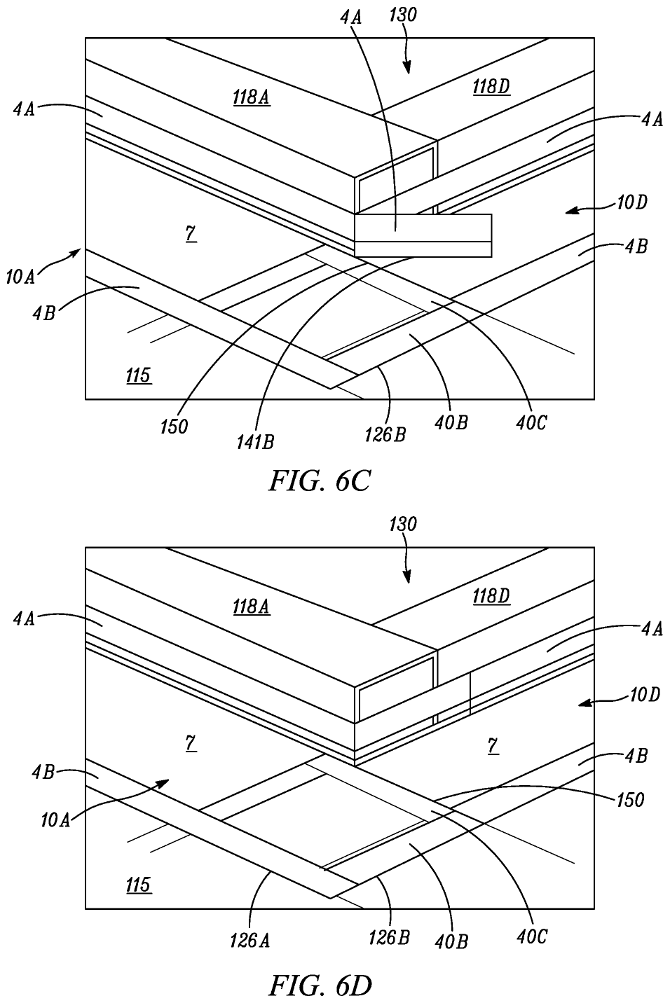

FIGS. 6A-6D illustrate a method in accordance with the invention for sealing around an insert 130 that protrudes from a surrounding building structure 115. A similar overall technique can be used for inserts positioned recessed from the plane of the surrounding wall. In FIG. 6A, insert frame members 118A and 118D protrude from building structure 115, forming a raised corner. The joint between frame member 118D and building structure 115 is sealed by applying self-adhering barrier sheet 10D across the joint (FIG. 6B). Self-adhering barrier sheet 10D is as generally shown in FIG. 3, consisting of a flexible sheet 20 that has tapered edges 4A and 4B and central section 7, and has, as shown, applied pressure sensitive adhesive strips 3 on the bottom of tapered edges 4A and 4B. Tapered edge 4B of self-adhering barrier sheet is adhered to building structure 115 by means of pressure sensitive adhesive 3. Central section 7 of self-adhering barrier sheet 10D spans the joint. Self-adhering barrier sheet 10D is adhered to insert frame member 118D and the end of insert frame member 118A by means of pressure sensitive adhesive 3. Self-adhering barrier sheet 10D extends past insert frame member 118A, being cut along edge 141A so it lays flat onto building structure 115. The section of adhering barrier sheet 10D extending past insert frame member 118A is adhered to building structure 115 via the pressure sensitive adhesive 3 applied to tapered edges 4A and 4B. In the embodiment shown, central section 7 of self-adhering barrier sheet 10D is only partially coated with pressure sensitive adhesive 3. Accordingly, an optional seal 40A can be provided to seal end 126A of self-adhering barrier sheet 10D to building structure 115. Optional seal 40A can be absent, particularly in embodiments in which the entire bottom surface of self-adhering barrier sheet 10D is coated with the pressure sensitive adhesive.

The joint between frame member 118A and building structure 115 is sealed by applying self-adhering barrier sheet 10A across the joint (FIG. 6C). Self-adhering barrier sheet 10A is as generally shown in FIG. 3, consisting of a flexible sheet 20 that has tapered edges 4A and 4B and central section 7, and has, as shown, applied pressure sensitive adhesive strips 3 on the bottom of tapered edges 4A and 4B. Tapered edge 4B of self-adhering barrier sheet 10A is adhered to building structure 115 and insert frame member 118A by means of pressure sensitive adhesive 3. Central section 7 of self-adhering barrier sheet 10A spans the joint. Self-adhering barrier sheet 10A extends past insert frame member 118A, being cut along edge 141B so it lays flat onto and overlaps self-adhering barrier sheet 10D. The section of self-adhering barrier sheet 10A extending past insert frame member 118A is adhered to self-adhering barrier sheet 10D via the pressure sensitive adhesive 3 applied to tapered edge 4B. The overlap produces seams 126B and 150. In the embodiment shown, central section 7 of self-adhering barrier sheet is only partially coated with pressure sensitive adhesive 3. Accordingly, optional seals 40B and 40C can be provided to seal seams 126B and 150. Optional seals 40B and 40C can be absent, particularly in embodiments in which the entire bottom surface of self-adhering barrier sheet 10A is coated with the pressure sensitive adhesive. The section of tapered edge 4A of self-adhering barrier sheet 10A that extends past frame member 118A is cut along edge 141B and folded over the end of insert frame member 118A (and, as shown, a portion of frame member 118D) and becomes adhered thereto by means of pressure sensitive adhesive 3, covering a portion of tapered edge 4A of self-adhering barrier sheet 10D, as shown in FIG. 6D.

Optional seals such as seals 40A, 40B and 40C may be of any material that produces an adhesive seal at the corresponding seam. An especially useful sealing material is a self-fusing silicone tape, which is widely available such as from RescueTape USA/Canada (www.rescuetape.com).

Although the invention is illustrated in FIGS. 2 and 6 with regard to an insert positioned within an opening in the building structure, the invention is not so limited. The invention is applicable to sealing a gap between any adjacent members in a building construction. In the embodiment illustrated in FIGS. 2 and 5, the adjacent members of the building construction are the building structure itself (15 in FIGS. 2 and 115 in FIG. 5) and the insert (reference numeral 30 in FIG. 2 and reference numeral 130 in FIG. 5). In other embodiments, the gap may be defined by, for example, any two adjacent members of a building structure itself which are spaced part, such as, for example, a gap between framing members (such as studs, floor, ceiling or roofing joints, or trusses; a gap between wall or other partition sections, a gap between floor or roof sections, a gap between a wall or other partition and a floor or roof.

Further, although the insert in FIGS. 2 and 6 is shown as a window, it is not so limited. The insert may be any structure that is inserted into a building structure for some functional or even aesthetic purpose. Examples of other inserts include a door; a door frame; a lintel; a skylight; a fan; an electrical panel; a vent; a chase for electrical, plumbing, HVAC or other conduits and/or cables; a mailbox or mail slot; an access panel; a frame or holder for a decorative element; among others. The insert in FIGS. 2 and 5 is shown as being rectangular, but again the geometry is not limited and the insert can have any shape as may be useful for its particular purpose.

Materials of construction of the building structure are not limited, so long as the pressure sensitive adhesive can form an adhesive bond thereto. The portions of the building construction to which the self-adhering barrier sheet can be applied may be, for example, metals such as aluminum, steel, copper; natural stone such as granite, marble, limestone and slate; cementitious material such as concrete, cinder blocks and mortar; cast materials such as brick and ceramic tile; fabricated products such as gypsum board; laminated insulating panels; wood products such as wood, plywood and oriented strand board; artificial wood products; dense and/or foamed polymer products such as vinyl siding and insulation board; among others. Any of these materials of construction may be coated by, for example, painting or another coating, or with a film (such as a moisture barrier or other protective film).

The geometrical shape of the gap is not critical so long as the insert is mechanically fastened within the opening and the gap can be spanned with the self-adhering barrier sheet. The gap width should be less than the width of the self-adhering barrier sheet so the sheet can be adhered to the building construction on each side of the gap. The self-adhering barrier sheet is particularly suitable for sealing gaps having a width of 1 to 610 mm of larger, especially 6 to 300 mm or 6 to 150 mm or 6 to 102 mm.

Flexible sheet 20 is a barrier to liquid water, preferably passing the water tightness test of EN1928:2000 Method B without leakage under conditions of 0.3 kPa pressure for at least 30 minutes. The material of construction for flexible sheet 20 is preferably an polymer, which may be thermoplastic or thermoset. Flexible sheet 20 preferably has an elongation to maximum load of at least 10%, preferably at least 50% or at least 100%, or at least 400% as measured by ASTM D412. In especially preferred embodiments, flexible sheet 20 exhibits a Shore A hardness of at least 20 and at most 80 or at most 60 (ASTM D2240-15). Flexible sheet 20 may be a unilayer material or a multilayer material. Examples of suitable materials of construction for flexible sheet 20 include elastomeric materials such as silicone rubber, polyurethane rubber, polyether rubber, polyester rubber, polyamide rubber, thermoplastic vulcanite, polyolefin rubbers such as ethylene-propylene or ethylene-propylene-diene monomer (EPDM) rubbers, polymers and copolymers of diene monomers such as butadiene, isoprene and chloroprene (including styrene/butadiene deblock and triblock copolymers), nitrile rubbers and natural rubber. Other suitable materials of construction include non-elastomeric polyolefins such as low density polyethylene, linear low density polyethylene, high density polyolefin, metallocene catalyzed polyolefins and the like. Flexible sheet 20 may be a composite material, or a multilayer coextruded or laminated material.

Pressure sensitive adhesive 3 may be, for example, a silicone, acrylic, so-called “modified acrylic” or natural or synthetic rubber type, and is generally selected in conjunction with the choice of flexible sheet and/or the building members to which it will be applied. Suitable pressure sensitive adhesive products are widely available from sources such as 3M, Adhesive Applications, Dow Chemical, Elkem Silicones, Lohmann GmbH & Co., and Sika Services AG. Pressure sensitive adhesive 3 may be applied directly to sheet 20 or provided in the form of a tape which is applied to some or all of bottom surface 8 of flexible sheet 20. In particular embodiments, pressure sensitive adhesive 3 is in the form of a double-sided tape that has two layers of pressure sensitive adhesive coated onto either side of a carrier film. The two layers of pressure sensitive adhesive may be the same or different; for example, one layer of pressure sensitive adhesive may be selected for its bonding properties to flexible sheet 20 whereas the other layer may be selected for its bonding properties to members of the building construction. In a particular embodiment, one layer of pressure sensitive adhesive may be a silicone or “modified acrylic” type for bonding to a silicone flexible sheet 20, and the other layer may be a general-purpose acrylic or natural or synthetic rubber type for bonding to the building construction.

Alternatively, pressure sensitive adhesive may be applied to bottom surface 8 of flexible sheet 20 in liquid form as a solution or as a melt that is subsequently solidified.

The thickness of pressure sensitive adhesive 3 is no greater than the maximum thickness of flexible sheet 20, and is preferably no greater than 50% or no greater than 10% thereof. In absolute terms, the thickness of pressure sensitive adhesive 3 may be, for example 0.01 to 0.75 mm, preferably 0.05 to 0.5 mm or 0.05 to 0.1 mm, but no greater than the maximum thickness of flexible sheet 20.

As shown in FIG. 3, pressure sensitive adhesive 3 may be covered with protective film 6 for purposes of packaging, storage and/or transportation. Protective film 6 is removed to expose pressure sensitive adhesive 3 prior to installing self-adhering barrier sheet 10.

Flexible sheet 20 is conveniently manufactured by extruding a melt of the flexible sheet material(s) through a die that has the corresponding cross-sectional geometry. Extrusion processes are well-adapted for continuous production. Other manufacturing methods can be used including, for example, extruding or casting a flat sheet and then producing the beveled areas by some post-extrusion or post-casting fabrication method (sanding, cutting, compressing, etc.); and molding. Pressure sensitive adhesive 3 is then applied to flexible sheet 20 as described before to produce self-adhering barrier sheet 10. It is also possible to produce self adhering barrier sheet 10 by fully or partially coating a wide “mother roll” of flexible material with adhesive and then producing one or more rolls of finished product with either one or both sides having tapered edges by appropriate slitting with straight or beveled angle cutting implements.

It is often useful to produce self-adhering barrier sheet 10 in the form of rollstock or standard lengths that are cut to the needed length upon application.

Installing the self-adhering barrier sheet is simple and easy. The self-adhering barrier sheet is cut to the needed length, if necessary. Protective film 6, if present, is removed, exposing pressure sensitive adhesive 3. The self-adhering barrier sheet is positioned such that it spans the gap between adjacent members of a building construction. A tapered edge 4A or 4B is adhered to one of the adjacent members by contacting it with that member and applying sufficient pressure to create an adhesive bond via the pressure sensitive adhesive. The opposing edge of self-adhering barrier sheet is then brought into contact with the other adjacent member and adhered to it in a similar manner. If desired in some embodiments, the self-adhering barrier sheet at first can be temporarily adhered to one or both of the adjacent members by applying only light pressure. This allows for repositioning and adjustment. Once the self-adhering barrier sheet is in its final position, greater pressure can be applied to produce a stronger adhesive bond to the members of the building construction. For example, the greater pressure may be applied using a roller.

In some embodiments, separate sections of the self-adhering barrier sheet are applied in such a way that they overlap at an angle. For example, multiple pieces of self-adhering barrier sheet may be installed to seal gaps around the periphery of an insert, in such a case those pieces of self-adhering barrier sheet applied to seal gaps adjacent sides of the insert preferably overlap at the corners. The angle may be, for example 5 to 175°, especially 30 to 150°, 45 to 135° or 60 to 120°. An overlapping section of self-adhering barrier sheet preferably crosses over at least one tapered edge of the overlapped self-adhering barrier sheet, as shown in FIG. 4, to avoid producing a gap such as gap 5 of FIG. 1.

### EXAMPLES

The following examples are provided to illustrate the invention and are not intended to limit the scope thereof.

A laboratory scale assembly consists of a wooden support frame with dimensions of 36″×36″ (91.44 cm×91.44 cm), to which four 0.25″ (6.35 mm) thick 17″×17″ (43.18 cm×43.18 cm) aluminum plates are affixed, leaving an open 2″ (50.8 mm) wide vertical gap, which was intersected by an open 2″ (50.8 mm) wide horizontal gap. The two gaps together form the shape of a “plus sign”. Elastomeric sheets, six inches (15.24 cm) wide with 1 inch (2.54 cm) wide strips of adhesive pre-applied at both outside edges of one side of the sheet are then used to seal the gaps between the aluminum plates. One of the elastomeric sheets is first applied over the horizontal gap by pressing it onto the adjacent aluminum panels. A weighted roller is then used to firmly press both edges of the silicone sheet onto the aluminum panels. Using the same technique, the other elastomeric sheet is then applied second, overlapping the horizontal sheet in the center of the assembly, at the intersection of the horizontal and vertical gaps formed by the aluminum plates.

The entire assembly is surrounded by an aluminum frame which allows it to be sealed to a rigid, aluminum-framed acrylic housing, which is serviced by a vacuum pump for applying subatmospheric pressure to the rear of the assembly. This housing is also fitted with a digital pressure transducer to measure the pressure differential from atmospheric pressure and appropriate control and bleed valves for monitoring and controlling the internal pressure. The evacuation line feeding the vacuum pump is equipped with a gas flowmeter to measure the total volumetric flow rate of gas needed (in standard liters per minute) to achieve a given vacuum level in the rear chamber. The air passage through the sealed gap area is then estimated by subtracting a reference leakage rate accounting for the frame seal with a barrier film over the active area from the total air passage. The front of the test assembly is surrounded by another chamber, open to the atmosphere, which holds a nozzle used for spraying recirculated water onto the exposed assembly. The air and moisture barrier of sealed test assemblies are assessed using this apparatus in accordance with a modified ASTM E331.

### Comparative Sample A

The elastomeric sheets in this sample are clear silicone sheets having a uniform thickness of 1.5 mm and a 58 Shore A hardness. The pressure-sensitive adhesive is a bilayer, acrylic-type adhesive transfer tape. When the edges of the overlapping vertical sheet are firmly pressed down over the horizontal sheet, a small gap is observed between the overlapping sheet and the aluminum substrate, identical to that shown in FIG. 1. A liquid sealant is applied to the four overlapping joint corners in an attempt to prevent water infiltration through the gap.

After waiting 24 hours to allow the sealants to sufficiently cure, the test assembly is installed into the testing apparatus described above. Shortly after beginning the test, with water spraying onto the test assembly at the lowest vacuum level (0.03 kPa) applied to the rear housing, water penetration through the overlapping sheets is observed through the clear panels of the rear housing, leading to accumulation of water at the bottom of the housing. The test is stopped since the assembly fails the barrier test.

### Example 1

The elastomeric sheets are clear silicone sheet having a Shore A hardness of 45, a center region having a uniform thickness of 0.9 mm, with tapered edges on both sides. The pressure sensitive adhesive is the same transfer tape as described in Comparative Sample A.

A smooth transition is observed at the junction where the vertical sheet overlapped the horizontal sheet, as shown in FIG. 4. No gap as shown in FIG. 1 is observed, and no liquid sealant is applied to the junction corners.

The test assembly is installed into the testing apparatus described above. A water spray is initiated onto the test assembly and the vacuum level applied to the rear housing is controlled manually at a rising series of differential pressures from atmospheric, each for a period of 15 minutes, while recording the pressure and the total air passage and watching for any water leakage from the rear of the test assembly. Observations are summarized in Table 1. Since no water leakage is observed up to a maximum differential pressure of 0.72 kPa from atmospheric, this sealing system is judged to have passed the air/moisture barrier test.

TABLE 1
Observations during Air/Moisture barrier
testing of test assembly in Example 1

| | Differential Vacuum Level | Total Air Passage | Water |
|---|---|---|---|
| Test | (kPa) | (SLPM) | Leakage? |
| 1 | 0.03 | 0.22 | No leakage |
| 2 | 0.082 | 0.53 | No leakage |
| 3 | 0.302 | 1.41 | No leakage |
| 4 | 0.433 | 2.36 | No leakage |
| 5 | 0.601 | 3.02 | No leakage |
| 6 | 0.725 | 3.31 | No leakage |

### Example 2

Example 1 is repeated, the elastomeric sheets in this case being silicone sheets as shown in FIG. 3. The silicone sheet has a 33 Shore A hardness. Its center region has a uniform thickness of 1.6 mm, while both edges on one primary side of the sheet have an included angle (4A as shown in FIG. 3) of 7°. The same bilayer, acrylic-type adhesive transfer tape used in Comparative Example 1 is employed for both pre-applied adhesive strips.

The test assembly is installed into the testing apparatus and tested in the same manner as for Example 1. Observations are summarized in Table 2. Since no water leakage is observed up to a maximum differential pressure of 0.72 kPa from atmospheric, this sealing system is judged to have passed the air/moisture barrier test.

TABLE 2
Observations during Air/Moisture barrier
testing of test assembly in Example 2

| | Differential Vacuum Level | Total Air Passage | Water |
|---|---|---|---|
| Test | (kPa) | (SLPM) | Leakage? |
| 1 | 0.032 | 0.04 | No leakage |
| 2 | 0.083 | 0.14 | No leakage |
| 3 | 0.313 | 0.53 | No leakage |
| 4 | 0.437 | 0.65 | No leakage |
| 5 | 0.606 | 0.84 | No leakage |
| 6 | 0.722 | 0.98 | No leakage |

What is claimed is:

1. A method of sealing a gap between adjacent members in a building construction, comprising:
applying a self-adhering barrier sheet to the adjacent members to span the gap with the self-adhering barrier sheet, wherein the self-adhering barrier sheet comprises a flexible sheet of a barrier material, the flexible sheet having opposing edges, at least one of said opposing edge being a tapered edge, and a pressure sensitive adhesive applied to at least a portion of at least one major surface of the flexible sheet, whereby said at least one tapered edge is adhered to one of the adjacent structural elements by means of the pressure sensitive adhesive and the opposing edge is adhered to the other of the adjacent structural elements by means of the pressure sensitive adhesive, wherein the flexible sheet has a minimum thickness of at least 0.5 mm and the pressure sensitive adhesive has a thickness equal to or less than the maximum thickness of the flexible sheet.

2. The method of claim 1 wherein separate sections of the self-adhering barrier sheet are applied and overlap at an angle, with an overlapping section of self-adhering barrier sheet being applied onto a overlapped section of self-adhering barrier sheet by crossing the overlapping section of self-adhering barrier sheet over at least one tapered edge of the overlapped section of self-adhering barrier sheet.

3. The method of claim 1 wherein the opposing edge of the flexible sheet is also tapered.

4. The method of claim 1 wherein each tapered edge forms an included angle of no greater than 15 degrees.

5. The method of claim 1 wherein the pressure sensitive adhesive is applied to at least one side of each of the tapered edges of the flexible barrier sheet.

6. A method of sealing an open joint between a building structure and an insert positioned within an opening in the building structure, comprising:
applying a self-adhering barrier sheet to the insert and the building structure to span the open joint with the self-adhering barrier sheet, wherein the self-adhering barrier sheet comprises a flexible sheet of a barrier material, the flexible sheet having opposing tapered edges and a pressure sensitive adhesive applied to at least a portion of at least each of the tapered edges, whereby one of the opposing tapered edges is adhered to the insert by means of the pressure sensitive adhesive applied to said one of the opposing tapered edges and the other opposing tapered edge is adhered to the building structure by means of the pressure sensitive adhesive applied to said other opposing tapered edge.

7. The method of claim 6 wherein the insert has multiple insert sides, each pair of adjacent multiple insert sides defining a vertex, and open joints are defined by each of said adjacent multiple insert sides and at least one side of the opening, separate sections of a self-adhering barrier sheet are applied to seal each of the open joints and the separate sections of self-adhering barrier sheet overlap at the vertices.

8. The method of claim 6 wherein the insert is a door or window, or frame for door or window or other building component.

9. The method claim 6 wherein each tapered edge forms an included angle of no greater than 15 degrees.

10. The method claim 6 where the pressure sensitive adhesive is applied to at least one side of each of the tapered edges of the flexible barrier sheet.

11. A self-adhering barrier sheet comprising;
a) a flexible sheet of a barrier material having a glass transition temperature of no greater than −40° C., the flexible sheet having a pair of opposing tapered edges and a maximum thickness of at least 0.5 mm, and
b) a pressure sensitive adhesive applied to at least one side of each of the opposing tapered edges, the pressure sensitive adhesive having a thickness no greater than the maximum thickness of the flexible sheet.

12. The self-adhering barrier sheet of claim 11, further comprising a removable protective covering over the pressure sensitive adhesive.

13. The self-adhering barrier sheet of claim 11, wherein the opposing tapered edges each form an included angle of no greater than 15 degrees.
